(19) United States
(12) Patent Application Publication
(10) Pub. No.: US 2010/0205144 A1
(43) Pub. Date: Aug. 12, 2010

(54) CREATING SEARCHABLE REVISIONS OF A RESOURCE IN A REPOSITORY

(75) Inventors: Lukas Barton, Prague (CZ); Martin Frydl, Prague (CZ); Svatopluk Dedic, Kladno (CZ)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Fort Collins, CO (US)

(21) Appl. No.: 12/369,203

(22) Filed: Feb. 11, 2009

(51) Int. Cl. G06F 17/30; G06F 7/00

(52) U.S. Cl. 707/608; 707/E17.044

(57) ABSTRACT

A method of creating searchable revisions of a resource for a resource repository is disclosed where a first revision of a resource is generated in the resource repository. The first revision of the resource can be approved, but the first revision of the resource is not accessible to a consumer searching the resource repository until the first revision of the resource is approved. A second revision of the resource subsequent to the first revision of the resource is generated, but the second revision of the resource is not accessible to a consumer searching the resource repository until the second revision of the resource is approved. A searchable artifact in the resource repository is also generated for each revision of the resource in the resource repository. The searchable artifact for the first revision of the resource includes for an approval field that indicates the first revision of the resource is valid from when the first revision of the resource is approved to when the second revision of the resource is approved.

### BACKGROUND

Many software applications use a resource repository, or a repository based on resources. Among these examples include applications for e-commerce, wikis including specialized wikis, and service-oriented architecture. Many more applications are currently being developed. Although much of this disclosure is provided in connection with a service-oriented architecture, this disclosure is not intended to be so limited to any such particular application.

A service-oriented architecture (SOA) is an architecture to design and provide services (such as resources from a repository) based on loosely coupled interactions between different types of software. The services can be developed in a modular form. Examples of SOA separate service descriptions from their implementations and use this descriptive metadata across a service life cycle. Standards-based service metadata artifacts, such as web service definition language (WSDL), XML schema, policy or service component architecture (SCA) documents, capture the technical details of what a service can do, how it can be invoked, what it expects other services to do, or the like. Semantic annotations and other metadata can be associated with these artifacts to provide insight to users of the service on how and when it can be used, and for what purposes it serves.

SOA governance provides a policy-management system for services throughout the service life cycle. Users of a governance platform can act in at least one of three roles, which includes a publisher, an approver, and a consumer. One of several available platforms for SOA governance is provided by Hewlett-Packard Company of Palo Alto, Calif., and sold under the trade designation of HP SOA Systinet, which is based on a repository containing resources. Governance platforms typically provide simple approval to a single resource at a time. Multiple resource approval is desirable. Policy validation can also be made a part of the approval. There is a continuing need to develop governance platforms.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a block diagram illustrating a general overview of a registry and repository system that can serve as an environment of the present disclosure.

FIG. 2 is a block diagram illustrating an implementation of resources in accordance with the present disclosure.

FIG. 3 is a schematic view illustrating an example approval process in relation to a timeline in accordance with the present disclosure.

FIG. 4 is a schematic view illustrating an example data structure related to the example approval process of FIG. 3.

FIG. 5 is a block diagram illustrating a comparison between a snapshot view and an approved view of a selected validation policy.

FIG. 6 is a block diagram illustrating an example approval process in accordance with policy validation.

FIG. 7 is a block diagram illustrating an example to-be-approved view and an approved view of the selected validation policy illustrated in FIG. 5.

### DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that the features of the various exemplary embodiments described herein may be combined with each other, unless specifically noted otherwise.

In this disclosure, a repository is analogous to a data store, and the data store includes several features. Included in these features is that a unit of stored data is a resource, the resources are arranged in a tree hierarchy, and the content and state of the resources can change with the changes traceable using a resource revision or time.

The unit of stored data can include several features. For example, the resource can be an access unit where only one resource can be read or modified per search request, which can make the resource analogous to a web page access. The content of the resource is composed of data, which can include references to other relationships such as in an outgoing relationship. Also, a resource state is resource content including data, outgoing relationships, and/or incoming relationships (such as relationships from other resources).

With respect to the tree hierarchy, a resource leaf is a data resource such as a file and includes data. A non-leaf resource is a collection such as a directory that can carry sub-resources. Each resource modification is stored as a revision so a complete history of all resource content can be available to a consumer.

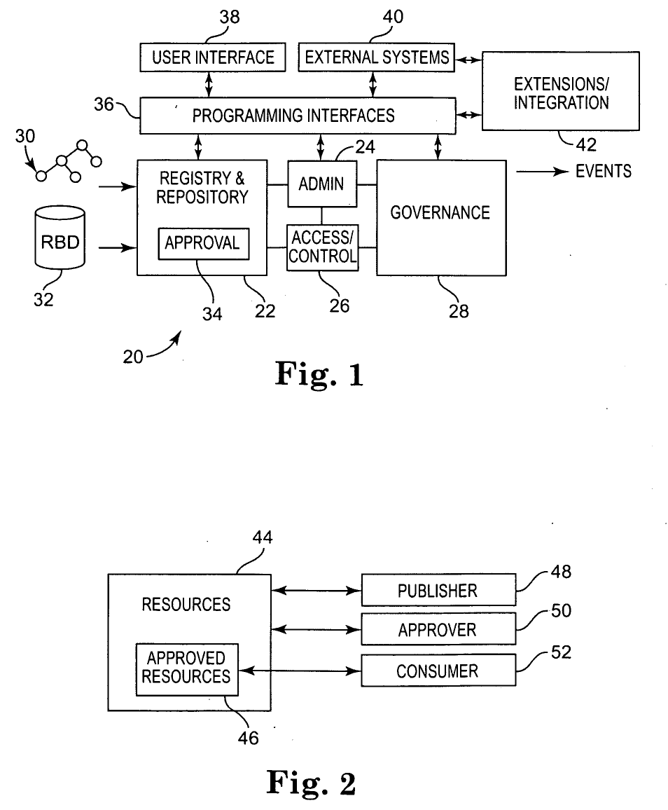

FIG. 1 illustrates an example registry and repository system 20 that can provide an example environment for the present disclosure. The registry and repository system 20 can be implemented on one or more general-purpose computer systems, such as an application server having at least one processor and a computer memory adapted to run and store one or more software applications.

In the example, the registry and repository system 20 includes components of a registry and repository 22, administration 24, access control 26, and governance 28. The components receive content models 30 and can use a relational database 32 as a backup store for metadata persistence.

The registry and repository 22 provides the ability to store, manage, and search service metadata artifacts holding service descriptions such as a web services description language (WSDL), an extensible markup language (XML) schema (XSD), WS-Policy, SCDL, or XML resources. Whenever a change to the content is detected, the registry and repository 22 invokes a registered approval system 34 typically initiated by a publisher in accordance with the governance component 28. The governance component 28 can include extensible functions and the ability to model life cycles. In connection with this, the governance component can be used to write and plug in approvers. It provides interfaces to analyze the changes in content and permits the auditing of such changes. The access control component 26 defines permissions and limits for the users. For example, some users may have limits that allow or deny certain types of actions on the system 20, such as a consumer may have a different set of privileges than an approver, and the like. The administration component 24 supports an exchange in information in the registry and repository system and supports interaction between the components.

The system 20 also includes a programming interface 36 that permit a user to interact with the system. The programming interface 36 in one example uses APP (Atom Publishing Protocol—REST) and other APIs to interact programmatically with the content of the system 20. The REST API can be used to communicate with XML data structures. A user interface 38 is coupled to the programming interface 36 and provides the main way that users often interface with the system 20. The programming interface 36 can also be coupled to external systems 40, which may need interface through an extension and integration module 42.

FIG. 2 illustrates an implementation of a collection of resources and its relation to users under in accordance with the present disclosure. The collection of resources includes an entire set of resources 44 including a subset of approved resources 46. A publisher 48 has access to the resources 44 in order to add new resources or to modify existing resources. An approver 50 also has access to these resources 44 in order to approve them. A consumer 52, however, only has access to the approved resources, and non-approved resources are not visible to the consumer 52. In this instance, the consumer 52 gets an approved view of the resources and not a “snapshot view” of all of the resources, whether approved or not, as they relate to each other.

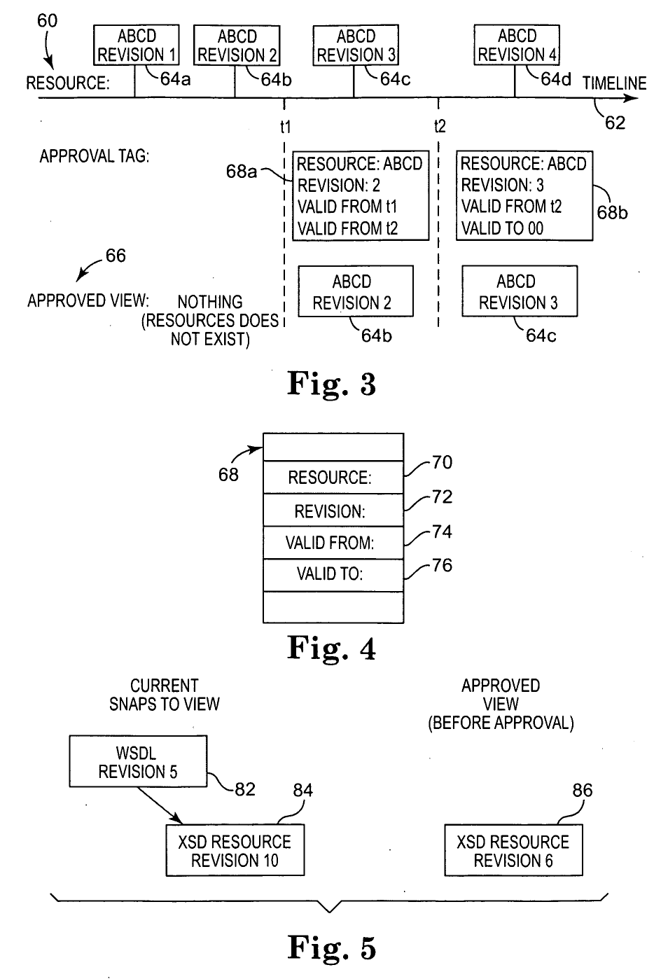

FIG. 3 illustrates an example approval process 60 in relation to a timeline 62. A resource is shown at various stages of development, revision, and approval at 64a, 64b, 64c, and 64d. In the example, the publisher creates resource 64a, which is given a name (such as ABCD) and given a revision number (such as revision 1). After the resource 64a is created, it can choose to revise ABCD and provide it with revision number 2. Neither revision 1 (64a) nor revision 2 (64b) is yet approved at this point on the timeline. Although a snapshot view includes revisions 1 and 2, 64a, 64b, an approved view 66 does not show information regarding the resource. In one example, a consumer can assume that the resource does not exist.

After the creation of resource revision 2, 64b, an approver can approve the resource 64b at time t1 along the timeline. The approved view 66 now shows the resource revision 2 64b as available to the consumer. If resource is modified again after time t1, such as a resource revision 3, 64c, the approved view will continue to show that revision 2, 64b is available. At time t2 along the timeline, resource revision 3, 64c is approved and the approved view now shows that this revision is available to the consumer.

An approval tag 68 is created as a resource artifact when a resource revision is approved and the content of the approval tag is revised after subsequent approval of revisions. It permits a consumer, publisher, approver, or other user to view approved data at any given time in the past. The approval tag also supports searching for approved revisions of resource.

FIG. 4 illustrates a more detailed view of one example of an approval tag 68. An approval tag can be formed as a data structure including at least one field. The example tag 68 includes several fields including a resource identifier 70, a revision number 72, an approved date 74 (i.e., a “valid from” date), and an approval expiration date 76 (i.e., a “valid to” date). In one example, the resource name can be a resource identifier such as a type of universal unique identifier (UUID) or uniform resource identifier (URI), which can include a uniform resource locator (URL). The approval expiration date can be the maximum date permitted by the implementation, such as an infinite date, or it can be a selected actual date in the future. The approval tag 68 can include other forms of information, of course, and other information about approval can include “approved stage,” “approvers' identification,” and the like, that can be used for searching.

Information about validity range, such as fields 74, 76, that is stored in each approval tag 68 allows for straightforward queries for past approval states and does not require any action within a repository. The use of the approval tag range and previous revisions of resources does not modify resources on approval because modifications would include repository features such a resource locking when approval is running, revision-less update and metadata model changes, and the like as in models of the prior art.

Returning to the example of FIG. 3, approval tags 68a and 68b are shown corresponding to resource revisions 2 and 3, (64b and 64c) respectively. Approval tag 68a shows revision 2 (64b) of resource ABCD is valid from time t1. Upon approval of resources revision 3 (64c), resource tag can show that resource revision 2 (64b) is valid until time t2, which is the time resource revision 3 is approved. Approval tag 68b shows revision 3 (64c) of resource ABCD is valid from time t2 and valid through an “infinite,” which valid through time can be changed at a future time if and when resource revision 4 (64d) is approved.

Implementing an approved view of a single resource includes checking the approval tag 68 for the resource identifier 70 and finding the approved revision where the current time is between the approved date 74 and the expiration date 76. The resource is returned to the consumer with the revision defined by the approval tag 68. If no revision exists matching corresponding with the name and date, an exception is created.

In order for a consumer to browse and search collections of approved resources at a given time, the scope of the search is changed from a specific revision to all revisions of the resource. The search conditions are extended with approval related restrictions as was defined in obtaining an approved view. In one implementation, the repository returns all revisions matching a consumer's query condition. In one example, new extension points are added into the existing query mechanism that allows for the modification of queries when an approved view is requested.

Another scenario is involved when the resource searched for is a root resource in a set of incoming-related resources. In other words, the root resource is related to other resources in a tree structure that also follow the approval process 60. A first example illustrated below includes a WSDL resource in an XML schema such as an XSD, resource. A second example illustrated below includes business service resource in an implementation resource in a WSDL in an XSD. In this case, the related resource, the root resource, and the relation compliant with a policy are all approved in the snapshot view then the resources and the relationship will appear in the approved view. If not, then latest approved root resource is shown with the latest valid relationship to the related resource is shown.

FIG. 5 illustrates an example comparison between a current snapshot view and an approved view of an implementation of a selected policy 80 of the first example. In the example, the snapshot view provides a root resource such as an XSD 82, in revision number 10, including a related WSDL 84, in revision number 5. In this example, XSD 82, revision 10, is not approved and the relationship with WSDL 84, revision 5, does not comply with the selected policy. Accordingly, the approved view only shows XSD 86, revision 6, i.e., the latest valid resource, and no relation to a WSDL.

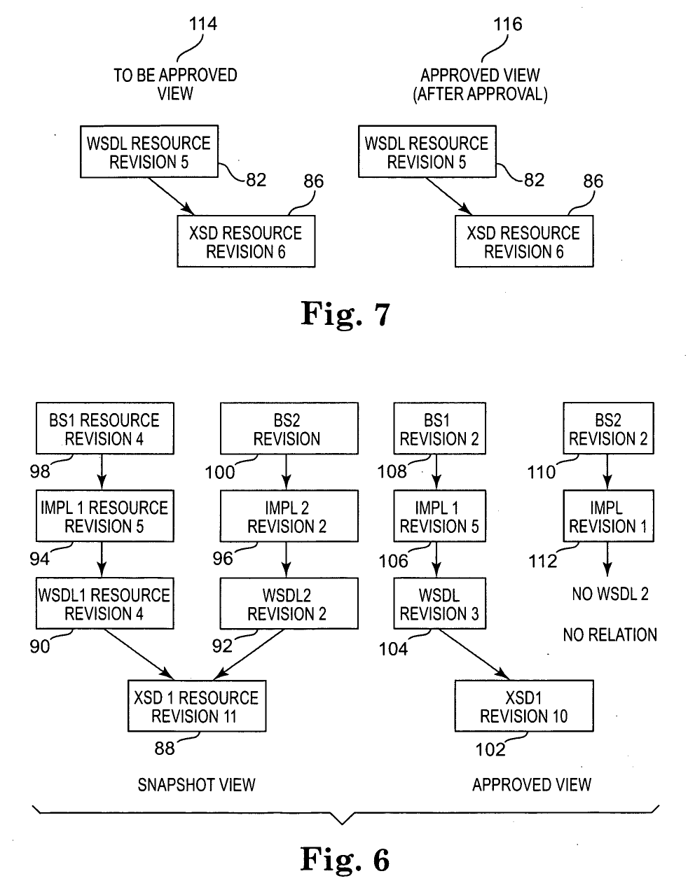

FIG. 6 illustrates another example comparison between a current snapshot view and an approved view of the second example. The snapshot view, the root resource XSD 88, revision 11, includes a first WSDL 90 and a second WSDL 92. The first WSDL 90, revision 4, includes a first implementation resource 94. The second WSDL 92, revision 2, includes a second implementation resource 96. The first implementation resource 94, revision 5, includes a first business service 98. The second implementation resource 96, revision 4, includes a second business service 100. The first business service resource 98 is in revision 4 and the second business service resource 100 is in revision 7.

In the approved view, however, the approved root resource 102 is XSD revision 10. The valid relationship between XSD 102 and an approved first WSDL 104 is revision 3. The valid relationship between WSDL 104 and an approved first implementation 106 is revision 5. And the valid relationship between first implementation 106 the first business service resource 108 is revision 2.

The approved second business service resource 110, revision 2, includes a valid relation with the second implementation resource 112, revision 1. In the example, the second WSDL 92 is not approved for revision 2 and no valid relation exists between the second implantation resource revision and a prior revision of the second WSDL 92. This follows that from the approved view of XSD 102, an incoming relation from the second WSDL is not present and that the second WSDL revision 2 (92) is not yet approved.

FIG. 7 relates to FIG. 5, and illustrates a to-be-approved view 114 and an approved view 116 of XSD 86, revision 6, and WSDL 82, revision 5. In the case of the to-be-approved view, the relation between the current approved XSD 86, revision 6, and yet to be approved WSDL, 82, revision 5 complies with the selected policy, and thus can be considered in a to-be-approved view 114. An approver can approve the to-be-approved view to become the approved view 116.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of creating searchable revisions of a resource for a resource repository, the method comprising:
generating a first revision of a resource in the resource repository;
approving the first revision of the resource, wherein the first revision of the resource is not accessible to a consumer searching the resource repository until the first revision of the resource is approved;
generating a second revision of the resource subsequent to the first revision of the resource, wherein the second revision of the resource is not accessible to a consumer searching the resource repository until the second revision of the resource is approved;
generating a searchable artifact in the resource repository for each of the first revision and the second revision of the resource, wherein the searchable artifact associated with the first revision of the resource and includes an approval field indicating the first revision of the resource is valid from when the first revision of the resource is approved to when the second revision of the resource is approved.

2. The method of claim 1 comprising implementing the resource repository in a service oriented architecture.

3. The method of claim 2 wherein the service oriented architecture includes a governance function.

4. The method of claim 1 wherein the generating the first revision of a resource in the resource repository includes storing the first revision in the resource repository prior to approving the first revision of the resource.

5. The method of claim 1 comprising creating a snapshot view including access to the first revision of the resource and the second revision of the resource prior to approval of the second revision of the resource.

6. The method of claim 5 wherein the snapshot view is accessible to a publisher of the revisions of the resource.

7. The method of claim 5 wherein the first revision of the resource is approved.

8. The method of claim 7 comprising creating an approved view based on the snapshot view wherein the first revision of the resource and not the second revision of the resource are accessible to a consumer.

9. The method of claim 1 wherein the searchable artifact is a data structure.

10. The method of claim 1 comprising:
generating a leaf resource related to the first revision of the resource, wherein a relationship between the leaf resource and the first revision of the resource comply with a selected relationship policy;
approving the leaf resource and the first revision of the resource; and
permitting the consumer access to the first revision of the resource and the leaf resource.

11. A computer-readable storage medium storing computer-executable instructions for controlling a resource repository, the computer-executable instructions comprising:
instructions for permitting a publisher to create and store multiple revisions of a resource in the resource repository;
instructions for permitting an approver to approve at least one of the revisions of the resource;
instructions for creating a searchable data structure including a first field for a resource identifier for each of the revisions of the resource, the searchable data structure also including at least one field configured to indicate whether the revision of the resource is approved;
instructions for permitting a consumer to search the data structures for a selected resource corresponding to the resource identifier from the multiple revisions of the resource; and
instructions for returning to the consumer the resource corresponding with the resource identifier if the field indicates the resource is approved.

12. The computer-readable storage medium of claim 11 wherein the multiple revisions of a resource are sequential in time and include a first revision and a second revision.

13. The computer-readable storage medium of claim 12 wherein the first revision is an approved resource as indicated in the data structure and the second revision is not an approved resource, wherein the instructions provide access to the first revision of the resource and not the second revision of the resource.

14. The computer-readable storage medium of claim 12 where in the first and second revisions of the resource are approved and both accessible to the consumer.

15. The computer-readable storage medium of claim 11 wherein the instructions are included in a service oriented architecture.

16. The computer-readable storage medium of claim 11 comprising instructions permitting linking a revision of the resource to a leaf resource if the relationship complies with a selected policy.

17. The computer-readable storage medium of claim 16 comprising instructions for permitting access to the leaf resource by a consumer when the leaf resource and the revision of the resource linked to the leaf resource are approved.

18. The computer-readable storage medium of claim 16 wherein the leaf resource is in a web services description language and the revision of the resource is in an extensible markup language schema.

19. The computer-readable storage medium of claim 11 wherein the at least one field of the data structure configured to indicate whether the revision of the resource is approved comprises a field to indicate an approved time of the revision of the resource and field to indicate an expiration of validity of the revision of the resource.

20. A computer-readable storage medium storing computer-executable instructions for controlling a resource repository in a service oriented architecture, the computer-executable instructions comprising:
instructions for permitting a publisher to create and store multiple revisions of a resource in the resource repository of the service oriented architecture;
instructions for permitting an approver to approve at least one of the revisions of the resource;
instructions for creating a searchable data structure including a field for a resource identifier for each of the revisions of the resource, wherein each of the data structures includes a valid from field configured to indicate a time when the resource was approved if the resource was approved, and a second field as to when the revision of the resource is valid if the resource was approved;
instructions for permitting a consumer to search the data structures for all approved revisions of the resource.
